(19) United States
(12) Patent Application Publication
(10) Pub. No.: US 2024/0328449 A1
(43) Pub. Date: Oct. 3, 2024

(54) Adjustable Torqueing System

(71) Applicant: TUSAS-TURK HAVACILIK VE UZAY SANAYII ANONIM SIRKETI, Kahramankazan/Ankara (TR)

(72) Inventor: Fatih TURK, Kahramankazan/Ankara (TR)

(21) Appl. No.: 18/620,638

(22) Filed: Mar. 28, 2024

(30) Foreign Application Priority Data
Mar. 31, 2023 (TR) 2023/003522

(51) Int. Cl. F16B 31/02

(52) U.S. Cl. CPC F16B 31/02

(57) ABSTRACT

An adjustable torqueing system for a plurality of bodies where at least one hole is located on each body. A fastener is inserted into the holes that are concentric with each other and an inner nut that is placed on the fastener holds the bodies together by keeping the fastener fixed on the bodies and in the hole. An outer nut that is placed on the inner nut by a user surrounds the inner nut. An outer surface is located at an area of the inner nut and contacts the outer nut. An inner surface located at an area of the outer nut contacts the inner nut, and a plurality of protrusions located on the outer surface consecutively around the direction that the outer surface extends a plurality of tabs located on the inner surface consecutively around the direction that the inner surface extends.

### CROSS-REFERENCE TO RELATED APPLICATIONS

This patent application claims the benefit and priority of Turkish Patent Application No. 2023/003522, filed on Mar. 31, 2023, the disclosure of which is incorporated by reference herein in its entirety as part of the present disclosure.

### FIELD

For the bolt-nut systems used in the assembly of parts used in the aviation field, several fasteners attached to the part during assembly must be installed by applying standard torque. The reason for this is that since a plurality of binding nut combinations is used on a part, each of them must be tightened with a different constant torque predetermined by the user. Additionally, if excessive torque force is applied to fasteners, which are made of metal materials, yielding or plastic-like deformation may be observed. To prevent this, torque wrenches are typically used in such assembly processes to determine whether the desired reference torque value has been reached or not. However, for small-sized parts or those that need to be assembled in tight spaces, usage of torque wrenches is not possible. In such cases, methods employing ratchet mechanisms are utilized to prevent further torque from being transferred to the fastener once the desired torque level is reached.

### BACKGROUND

U.S. Pat. No. 2,685,812A, which is included in the known-state of the art, discloses a constant torque application system developed for a nut fastener system, which is tightened so as not to exceed a desired torque value even if excessive torque is applied by the user. According to this invention, two nuts with a ratchet mechanism are positioned on top of each other. When the threshold torque value is exceeded, the applied torque is not transferred to the fastener, thus protecting the fastener

U.S. Pat. No. 3,425,314A, which is included in the known-state of the art, discloses a nut connector system to hold two parts together. Thanks to the dedicated internal threads provided for the nut in this invention, excess torque is not transferred to the fastener, thereby protecting the fastener.

### SUMMARY

Thanks to an adjustable torqueing system according to the present invention, an ergonomic torqueing system with an adjustable structure is provided, which can meet the torque requirements of the fasteners at different values.

Another object of the present invention is to ensure easy assembly or disassembly of structural parts of air vehicles in narrow and limited spaces.

A further object of the present invention is to transfer the predetermined torque value to the fastener without causing any damage.

The adjustable torqueing system, which is defined in the first claim and other claims dependent thereon, comprises at least one hole positioned concentrically on multiple overlapping bodies; a fastener removably fitted into the holes; an internal nut that enables assembly of the bodies to each other by keeping the fastener in a fixed position on the bodies and in the holes; an outer nut which is removably attached by the user on the inner nut to almost completely enclose the inner nut; an outer surface where the inner nut is in contact with the outer nut; an inner surface located opposite the outer surface, on a face of the outer nut in contact with the inner nut; a plurality of protrusions located on an upper part of the outer surface, sequentially around the direction in which the outer surface extends; a plurality of tabs positioned on the inner surface, sequentially around the direction in which the inner surface extends.

The adjustable torqueing system according to the invention comprises a ring with a varying cross-sectional area along the direction it extends, wherein the ring is placed on the outer nut, concentrically with the outer nut, and deforms at least partially one of the protrusions and/or tabs, wherein if the ring is rotated by the user around the direction it extends, the ring itself moves on the gear thereon, so that the outer nut approaches the inner nut, thereby providing a contact between the inner surface and the outer surface; the outer nut which enables the inner nut to be sandwiched between the outer nut and the fastener when the ring is moved on the gear path, and which enables the fastener to be fixed on the bodies when the user applies a torque.

In an embodiment of the invention, the adjustable torqueing system comprises a wall located at a part where the outer nut contacts the ring, wherein the wall has helical gears on the surface contacting the ring, wherein the wall enables the narrowing cross-sectional area of the ring to to move towards the outer nut when the ring is rotated around the direction it extends.

In an embodiment of the invention, the adjustable torqueing system comprises the ring that applies pressure to the wall thanks to its walls approaching each other, when the ring with a conical form is rotated around its own direction; the inner surface and outer surface approaching each other as a result of the pressure of the wall.

In an embodiment of the invention, the adjustable torqueing system comprises at least one indicator containing signs such as numbers, letters, lines, etc. that convey to the user the degree of torque to be applied, wherein the indicator enables the determination of the amount of torque to be transferred as a result of the user rotating the ring and tightening the inner nut by pressing the wall; a thread on the outer nut, which enables the user to see the level of the ring.

In an embodiment of the invention, the adjustable torqueing system comprises the inner nut rotated by the user by a predetermined amount so as to be placed on the fastener; the outer nut placed over the inner nut such that the protrusion and/or tab can at least partially contact thereto, the ring positioned on the outer nut so as to be in contact with the wall, the ring which is rotated around the direction it extends to bring the thread to the level on the indicator that indicates the level equivalent to the torque that the user should apply to the fastener.

In an embodiment of the invention, the adjustable torqueing system comprises an axis located on a face where the tab and the outer walls of the protrusion are in contact with each other; a first angle, which is a concave angle positioned between the axis and the opposite face of the protrusion, wherein the first angle approaches zero when the ring is rotated around the direction it extends to compress the outer nut towards the inner nut such that the tab deforms the protrusion elastically during torqueing of the outer nut.

In an embodiment of the invention, the adjustable torqueing system comprises a second angle with a degree greater than the first angle, which is located on the recesses between the axis and successive tabs.

In an embodiment of the invention, the adjustable torqueing system comprises the tab which is inserted into the recess that the second angle faces, so as to contact the outer wall thereof, when the outer nut is torqued in the opposite direction, thereby allowing the inner nut to be disassembled and removed from the fastener.

In an embodiment of the invention, the adjustable torqueing system comprises a slot located at a place where the ring surrounds the wall, wherein the slot forms a recess at a part of the ring where it is placed partially on the outer nut, almost creating a gap.

In an embodiment of the invention, the adjustable torqueing system comprises the ring having a recessed surface so that the user can easily grasp it.

In an embodiment of the invention, the adjustable torqueing system comprises a pin that is removably attached to the fastener, so that the ring is not removed from the fastener when it contacts the ring.

### BRIEF DESCRIPTION OF THE DRAWINGS

The adjustable torqueing system realized to achieve the object of the present invention is illustrated in the attached drawings;

FIG. 1 is a front view of the adjustable torqueing system.

FIG. 2 is a perspective view of the adjustable torqueing system.

FIG. 3 is a perspective view of the adjustable torqueing system.

FIG. 4 is a front view of the adjustable torqueing system.

FIG. 5 is a top view of the outer surface, inner surface, protrusion, tab, axis, first angle and second angle.

All the parts illustrated in figures are individually assigned a reference numeral and the corresponding terms of these numbers are listed below:
1. Adjustable torqueing system
2. Body
3. Fastener
4. Inner nut
5. Outer nut
6. Outer surface
7. Inner surface
8. Protrusion
9. Tab
10. Ring
11. Wall
12. Indicator
13. Thread
14. Slot
15. Pin
(D) Hole
(x) Axis
(α) First angle
(β) Second angle

### DETAILED DESCRIPTION

The adjustable torqueing system (1) comprises a plurality of bodies (2); at least one hole (D) that is located on each body (2); a fastener (3) that is inserted into the holes (D) that are concentric with each other; an inner nut (4) that is placed on the fastener (3) and holds the bodies (2) together by keeping the fastener (3) fixed on the bodies (2) and in the hole (D); an outer nut (5) that is placed on the inner nut (4) by a user and surrounds the inner nut (4); an outer surface (6) located at an area of the inner nut (4) that contacts the outer nut (5); an inner surface (7) located at an area of the outer nut (5) that contacts the inner nut (4); a plurality of protrusions (8) located on the outer surface (6), consecutively around the direction that the outer surface (6) extends; a plurality of tabs (9) located on the inner surface (7), consecutively around the direction that the inner surface (7) extends.

The adjustable torqueing system (1) according to the invention comprises a ring (10) with a plurality of different cross-sectional areas along its length, which is positioned on the outer nut (5) to be concentric with the outer nut (5), wherein the ring (10) is rotated around its own direction by the user and compresses the outer nut (5) towards the inner nut (4) by means of the gear path thereon, so that the inner surface (7) and the outer surface (6) almost completely contact with each other, wherein the ring (10) enables at least one of the protrusion (8) and/or the tab (9) to be partially deformed; the outer nut (5) that compresses the inner nut (4) by means of the ring (10), wherein if the user applies a torque on the outer nut (5), the fastener (3) is fixed.

In order for a plurality of bodies (2) to be fixed to each other, there is provided a hole (D) on each body (2) concentrically. A fastener (3) placed inside these holes (D) enables the bodies (2) to be connected to each other. An inner nut (4) is slightly rotated by the user and placed on the fastener (3), so that the bodies (2) can hold onto each other and remain fixed. An outer nut (5) is placed on the inner nut (4) by the user, from the upper part of the inner nut, such that it almost surrounds the inner nut (4). There is an outer surface (6) on a face of the inner nut (4) that is in contact with the outer nut (5); and an inner surface (7) opposite the outer surface (6), on a face of the inner nut (4) that is in contact with the outer nut (5). There is a plurality of protrusions (8) on the outer surface (6), located consecutively and sequentially around the direction in which the outer surface (6) extends along its length. A plurality of tabs (9) are provided on the inner surface (7), consecutively and sequentially around the direction in which the inner surface (7) extends along its length. Thanks to the contact between the protrusion (8) and the tab (9), the outer nut (5) rotated around its own axis by the user can transfer the torque applied thereon to the inner nut (4) and the fastener (3).

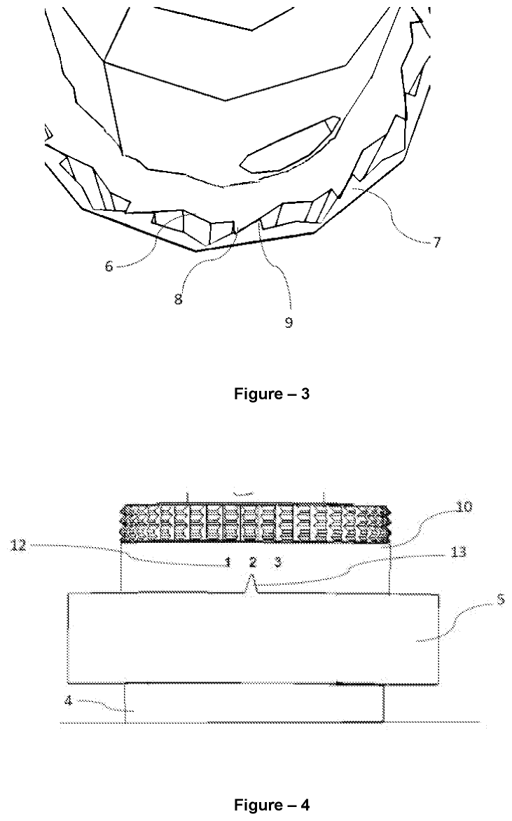

A ring (10) is placed on the outer nut (5), which compresses the outer nut (5) thanks to its conical form. The cross-sectional area of the ring (10) is different along its length and is positioned on the outer nut (5) so as to be concentric with the outer nut (5). By rotating the ring (10) around itself, it moves through the gear path thereon, and compresses the outer nut (5) against the inner nut (4). Thus, the inner surface (7) and the outer surface (6) are enabled to come into almost complete contact with each other. When the inner surface (7) and the outer surface (6) contact each other, at least one of the protrusion (8) and/or the tab (9) is partially deformed. The outer nut (5) compresses the inner nut (4) when compressed by the ring (10), and enables the fastener (3) to be fixed on the bodies (2) when a torque is applied thereon by the user. In this way, the amount of torque determined by the user is transferred to the fastener (3) (FIG. 1, FIG. 3).

In an embodiment of the invention, the adjustable torqueing system (1) comprises a wall (11) that is located at a section of the outer nut (5) that contacts the ring (10), wherein the wall (11) has helical-shaped gears on a surface thereof in contact with the ring (10), and enables the section with a narrowed cross-sectional area to approach the outer nut (5) when the ring (10) is rotated. Thanks to the helical gears on the wall (11) connected to the outer nut (5), when the ring (10) is rotated around itself, it moves up or down on the wall (11). Therefore, the amount of torque to be transferred by the outer nut (5) to the inner nut (4) can be adjusted.

In an embodiment of the invention, the adjustable torqueing system (1) comprises the ring (10) which has walls approaching each other when the ring (10) in conical form is rotated around itself, so that the wall (11) is compressed; the inner surface (7) and outer surface (6) that approach each other upon the compression of the wall (11). Therefore, the wall (11) with a lower cross-sectional area presses the outer nut (5) towards the inner nut (4). In this way, the torque applied to the outer nut (5) can be effectively transferred to the inner nut (4).

In an embodiment of the invention, the adjustable torqueing system (1) comprises at least one indicator (12) that is located on the ring (10), with a mark thereon indicating the positions to be adopted by the ring (10) when rotated around the direction it extends, wherein the indicator (12) enables the user to choose the torque to be applied; a thread (13) that is located on the outer nut (5) and enables the user to see the level that the ring (10) has been moved by being rotating around the direction it extends. The number and similar marks on the indicator (12) indicate the amount of torque predetermined by the user on the fastener (3). When the ring (10) is rotated by one level, the amount of torque to be applied is also changed. The thread (13) located on the outer nut (5) enables the user to see the level on the indicator (12) as the ring (10) is rotated. Therefore, the amount of torque to be applied can be adjusted with a single ring (10) and the user can easily see and select this value on the indicator (12) (FIG. 4).

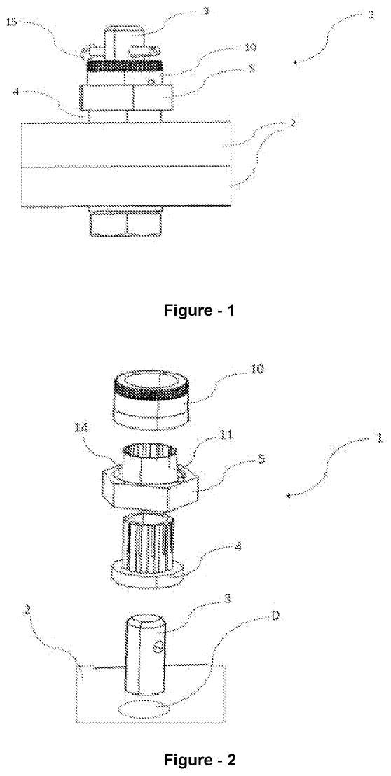

In an embodiment of the invention, the adjustable torqueing system (1) comprises the inner nut (4) rotated by the user by a predetermined amount so as to be placed on the fastener (3);
the outer nut (5) placed on the inner nut (4) such that the protrusion (8) and tab (9) at least partially contact thereto,
the ring (10) placed on the outer nut (5) so as to be in contact with the wall (11),
the ring (10) which is rotated around the direction it extends to bring the thread (13) to the level on the indicator (12) that indicates the level equivalent to the torque determined by the user. First of all, the inner nut (4) is rotated to be moved through the gear path of the fastener (3) previously placed in the holes (D), so that the inner nut (4) is fixed on the fastener (3), and in the meantime, a torque less than necessary is applied. The outer nut (5) is placed on the inner nut (4) by ensuring that the tabs (9) on the outer nut (5) pass through each other in accordance with the form of the protrusions (8) on the inner nut (4). The ring (10) is rotated to be moved through the gear path of the wall (11) on the outer nut (5) and positioned on the outer nut (5) in contact with the wall (11). The ring (10) is always placed first on the wall (11) so that the lowest level on the indicator (12) is on the thread (13). As the ring (10) is rotated by the user, the level on the indicator (12) changes, which is indicated by the thread (13) to the user. Therefore, the torque desired by the user can be applied to the fastener (3) (FIG. 2).

In an embodiment of the invention, the adjustable torqueing system (1) comprises an axis (x) located on a face where the tab (9) and the outer walls of the protrusion (8) are in contact with each other; a first angle (α), which is a concave angle positioned between the axis (x) and the opposite face of the protrusion (8), wherein the first angle (α) approaches zero when the ring (10) is rotated around the direction it extends to compress the outer nut (5) towards the inner nut (4) such that the tab (9) deforms the protrusion (8) elastically during torqueing of the outer nut (5). The transfer of the torque, which has been applied by the user to the outer nut (5), to the inner nut (4) varies depending on the contact surface area of the tab (9) and the protrusion (8). If a more amount of torque is applied to the inner nut (4) than the reference torque value desired by the user, the first angle (α) approaches zero. Thus, the tab (9) causes the protrusion (8) to undergo elastic deformation, reducing the contact surface area and thus preventing the application of excessive torque.

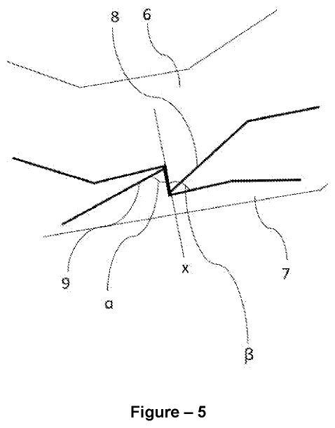

In an embodiment of the invention, the adjustable torqueing system (1) comprises a second angle (β) greater than the first angle (α), which is located between the axis (x) and the recess between consecutive tabs (9). In this way, when the outer nut (5) is reverse torqued, the protrusions (8) fit into the face faced by the angle between the tabs (9), and provide more effective torque transfer (FIG. 5).

In an embodiment of the invention, the adjustable torqueing system (1) comprises the tab (9) fitted on the second angle (β) and contacting the wall of the protrusion (8) when the outer nut (5) is torqued in the opposite direction, thus enabling the disassembly of the inner nut (4). When the outer nut (5) is torqued in the opposite direction, the protrusion (8) is fitted into the recesses between the tabs (9), contacts the face on which the axis (x) is located, and settles on the second angle (β). Thus, the disassembly of the outer nut (5) is ensured (FIG. 5).

In an embodiment of the invention, the adjustable torqueing system (1) comprises a slot (14) located on a part of the ring (10) that surrounds the wall (11), so as to create a recess on a part of the ring (10) that is at least partially placed on the outer nut (5). Therefore, the ring (10) is positioned on the outer nut (5) by almost surrounding the wall (11) and placed inside the slot (14).

In an embodiment of the invention, the adjustable torqueing system (1) comprises the ring (10) with a serrated surface, thereby facilitating the user to grip the ring (10). In this way, the user can easily adjust the compression level of the wall (11) by the ring (10).

In an embodiment of the invention, the adjustable torqueing system (1) comprises a pin (15) located on the fastener (3), which almost contacts the ring (10), thereby preventing the ring (10) from coming out of the fastener (3). Therefore, a more reliable system is created by preventing the ring (10), outer nut (5) and inner nut (4) from coming out of place.

What is claimed is:

1. An adjustable torqueing system (1) comprising:
a plurality of bodies (2);
at least one hole (D) that is located on each body (2);
a fastener (3) that is inserted into the holes (D) that are concentric with each other;
an inner nut (4) that is placed on the fastener (3) and holds the plurality of bodies (2) together by keeping the fastener (3) fixed on the plurality of bodies (2) and in the hole (D);
an outer nut (5) that is placed on the inner nut (4) by a user and surrounds the inner nut (4);
an outer surface (6) located at an area of the inner nut (4) that contacts the outer nut (5);
an inner surface (7) located at an area of the outer nut (5) that contacts the inner nut (4);
a plurality of protrusions (8) located on the outer surface (6), consecutively around a direction that the outer surface (6) extends;
a plurality of tabs (9) located on the inner surface (7), consecutively around a direction that the inner surface (7) extends;
a ring (10) with a plurality of different cross-sectional areas along its length, which is positioned on the outer nut (5) to be concentric with the outer nut (5), wherein the ring (10) is rotated around its own direction by the user and compresses the outer nut (5) towards the inner nut (4) by means of a gear path thereon, so that the inner surface (7) and the outer surface (6) almost completely contact with each other, wherein the ring (10) enables at least one of the plurality of protrusions (8) and/or the plurality of tabs (9) to be partially deformed; and
wherein the outer nut (5) compresses the inner nut (4) by means of the ring (10), wherein if the user applies a torque on the outer nut (5), the fastener (3) is fixed.

2. The adjustable torqueing system (1) according to claim 1, comprising a wall (11) that is located at a section of the outer nut (5) that contacts the ring (10), wherein the wall (11) has helical-shaped gears on a surface thereof in contact with the ring (10), and enables the section with a narrowed cross-sectional area to approach the outer nut (5) when the ring (10) is rotated.

3. The adjustable torqueing system (1) according to claim 2, wherein the ring (10) has walls approaching each other when the ring (10) in conical form is rotated around itself so that the wall (11) is compressed and the inner surface (7) and the outer surface (6) approach each other upon the compression of the wall (11).

4. The adjustable torqueing system (1) according to claim 1, comprising:
at least one indicator (12) that is located on the ring (10), with a mark thereon indicating the positions to be adopted by the ring (10) when rotated around a direction it extends, wherein the at least one indicator (12) enables the user to choose the torque to be applied; and
a thread (13) that is located on the outer nut (5) and enables the user to see a level that the ring (10) has been moved by being rotating around a direction it extends.

5. The adjustable torqueing system (1) according to claim 4, wherein the inner nut (4) is rotated by the user by a predetermined amount so as to be placed on the fastener (3); wherein the outer nut (5) is placed on the inner nut (4) such that the protrusion (8) and tab (9) at least partially contact thereto; wherein the ring (10) placed on the outer nut (5) so as to be in contact with a wall (11); and wherein the ring (10) is rotated around the direction it extends to bring the thread (13) to a level on the at least one indicator (12) that indicates a level equivalent to the torque determined by the user.

6. The adjustable torqueing system (1) according to claim 1, comprising:
an axis (x) located on a face where the tab (9) and outer walls of the protrusion (8) are in contact with each other;
a first angle (α) which is a concave angle positioned between the axis (x) and the opposite face of the protrusion (8); and
wherein the first angle (α) approaches zero when the ring (10) is rotated around the direction it extends to compress the outer nut (5) towards the inner nut (4) such that the tab (9) deforms the protrusion (8) elastically during torqueing of the outer nut (5).

7. The adjustable torqueing system (1) according to claim 1, comprising a second angle (β) greater than a first angle (α), which is located between an axis (x) and a recess between consecutive tabs (9).

8. The adjustable torqueing system (1) according to claim 7, wherein the tab (9) fitted on the second angle (β) and contacting a wall of the protrusion (8) when the outer nut (5) is torqued in the opposite direction, thus enabling disassembly of the inner nut (4).

9. The adjustable torqueing system (1) according to claim 2, comprising a slot (14) located on a part of the ring (10) that surrounds the wall (11) to create a recess on a part of the ring (10) that is at least partially placed on the outer nut (5).

10. The adjustable torqueing system (1) according to claim 1, wherein the ring (10) has a serrated surface, thereby facilitating the user to grip the ring (10).

11. The adjustable torqueing system (1) according to claim 1, comprising a pin (15) located on the fastener (3) which almost contacts the ring (10) and thereby prevents the ring (10) from coming out of the fastener (3).
